(19) United States
(12) Patent Application Publication
(10) Pub. No.: US 2007/0295153 A1
(43) Pub. Date: Dec. 27, 2007

(54) Combination compression/diaphragm coupling system

(76) Inventor: Galen E. Burdeshaw, Simpsonville, SC (US)

Correspondence Address: THOMPSON COBURN, LLP, ONE US BANK PLAZA, SUITE 3500, ST LOUIS, MO, 63101, US

(21) Appl. No.: 11/451,892

(22) Filed: Jun. 13, 2006

(51) Int. Cl. F16F 15/16

(52) U.S. Cl. 74/573.12

(57) ABSTRACT

A coupling system is disclosed for coupling rotating elements such as a flywheel and a shaft, pairs of shafts, and so forth. A flexible element is captured by a hub. The flexible element may be coupled to a first rotating member, such as a flywheel. The flexible element may be generally disk-like or tire-like. The hub presents an intermeshing interface, such as a series or recesses in a face thereof. A coupling member on the second rotating member has protruding extensions generally parallel to an axis thereof. The extensions intermesh with or engage the recesses of the hub to enable the assembly to be finally installed by stabbing motion of the extensions into the recesses.

### BACKGROUND

The current invention relates to the field of mechanical couplings. More specifically, the invention relates to a system that flexibly couples a shaft of one rotating member to a shaft or flywheel of another rotating member.

Mechanical systems often consist of a number of energy converting devices. A few examples of such devices include motors, pumps, alternators, generators, and turbines. These devices are often physically connected to one another via a mechanical coupling to realize the potential of one energy source by converting it into a more useful form. For example, the rotating shaft of an internal combustion engine may drive a flywheel that is, in turn, coupled to the shaft of a pump or other driven device. The mechanical coupling serves to transfer the kinetic energy generated by the engine to drive the load, particularly through transmitting torque to the load during operation.

A variety of mechanical couplings are known and commercially available for connecting one rotating member to a second rotating member. All of these couplings have limitations that impact their implementation and performance when used in a mechanical system. One limitation is that the couplings can be bulky and require more operating space than is available. A low profile coupling that can operate in a space constrained environment would be desirable.

Another limitation is that existing coupling systems are often difficult to install and implement, as well as to service, thus leading to a longer installation and downtime. In a particular application involving engine driven equipment, installation of a flywheel-mounted coupling element, along with mounting of its interfacing components on a driven shaft can be extremely tedious and time-consuming. This is particularly the case when the application calls for the driven load (such as a pump) is supported on the engine itself, as the coupling elements will be at least partially surrounded by support structures and therefore difficult to access. A coupling that is preassembled and easy to install would be preferable over a complex coupling with multiple parts.

A further limitation results from the misalignment of the coupled shafts. This misalignment can be both axial (offset centerlines) and angular (non-perpendicular faces or misaligned axes of the driving and driven machines). Practically speaking, this misalignment can never be completely eliminated. Those skilled in the art will appreciate the advantages of a coupling device that can still function even when the shafts or other rotating elements are not in perfect alignment. Some commercially available couplings address this issue but often do so at the cost of reduced torque carrying capacity. Such couplings often increase the internal clearance in the load bearing members of the coupling to allow for the misalignment. This can, however, reduce the life of the coupling and its ability to transfer torque efficiently. A coupling that could allow for this misalignment without sacrificing torque carrying capacity would be desirable.

Another issue arises as a result of dynamic imbalances inherent in any rotating device. At high rotations per minute (RPM) these imbalances can result in severe lateral, torsional, and axial vibrations which are then transmitted through the system via the coupling. These vibrations cause the system to run less efficiently and can also damage vibration sensitive devices, such as bearings. A coupling that can dampen and isolate vibration, thereby preventing transmission, would be of particular benefit.

Finally, many mechanical systems operate in environments where human interaction is common. Rotating components are therefore often enclosed by shields or other covers or mounted to an external housing. These covers often complicate the assembly process and make direct access to the coupling system difficult and taxing. Current commercially available couplings often require the user to complete the coupling mechanism after these covers are in place. This is particularly problematic when the coupling is only accessible through an access port of very limited dimensions. A coupling system that has an intermeshing interface that could be independently installed on the respective rotating components and then blindly stabbed together would be advantageous. The blind stab capability would eliminate the need for the user to complete the coupling interface through the tiny access port and allow for much more efficient assembly, disassembly, and servicing.

### BRIEF DESCRIPTION

The present invention offers a solution to all of the issues and problems that currently limit other commercially available mechanical couplings. The invention generally consists of two parts, a flexible hub assembly and a coupling element. The flexible hub assembly is a pre-assembled component that is easily installed and implemented on a first rotating member, thus reducing installation time. The assembly is low profile and can operate in a space-constrained environment. The hub assembly has a flexible element that allows for misalignment between the rotating members as well as functioning as a dampener for vibration isolation. Furthermore, the hub assembly uses elastomeric inserts that allow for reduced internal clearance in the coupling system. The coupling element is adapted to be secured to a second rotating member, and stabbed or axially mated with the hub assembly.

The net effect is that the system has a higher torque carrying capacity without over constraining the mechanical system or sacrificing coupling life. The system is blindly stabbable and is engaged with very little user interaction. The end user only needs to install the flexible hub assembly and coupling element onto their respective rotating members and then simply slide the two devices together. No further assembly is required eliminating the need to complete the coupling when direct access might be limited. All of these benefits reduce the time and difficulties in coupling one mechanical system to another without sacrificing performance or safety.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary flexible coupling assembly in accordance with aspects of the invention, illustrating the flywheel, flexible hub assembly, coupling element, and driven shaft;

FIG. 2 is a sectional view of the flexible coupling assembly of FIG. 1, sectioned along line 2-2, illustrating the internal elements of the coupling system;

FIG. 3 is a sectional view illustrating an alternative embodiment of the inventive coupling system designed for coupling two shafts to one another;

FIG. 4 is a sectional view illustrating a second alternative embodiment of the inventive coupling system.

### DETAILED DESCRIPTION

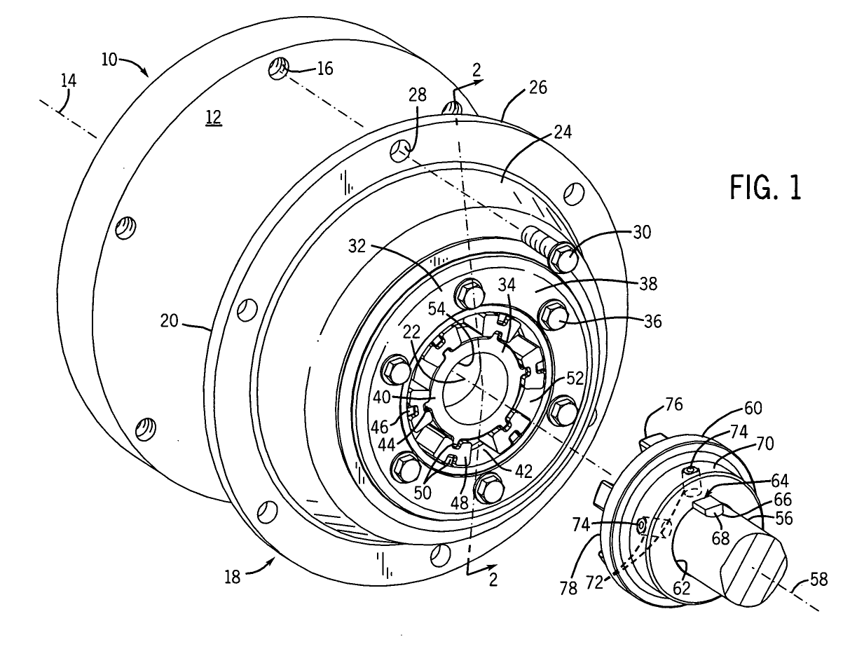

Turning now to the drawings, FIG. 1 illustrates a flywheel 10 having a front face 12 and rotating about an axis or centerline 14. The flywheel 10 represents the output interface of the first mechanical device. The flywheel 10 might be attached to an engine, for example, and driven by the engine during operation. The flywheel 10 has a plurality of threaded holes 16 located on the front face 12. The threaded holes 16 are located at a specified distance from the centerline 14 so as to permit securement of the coupling system as described below.

It should be noted that where, in the present discussion, reference is made to a driving or a driven element, this is for convenience only. As will be appreciated by those skilled in the art, the couplings and systems of the present invention may be used in a variety of contexts and with power or torque flow in the directions indicated here, or in an opposite direction.

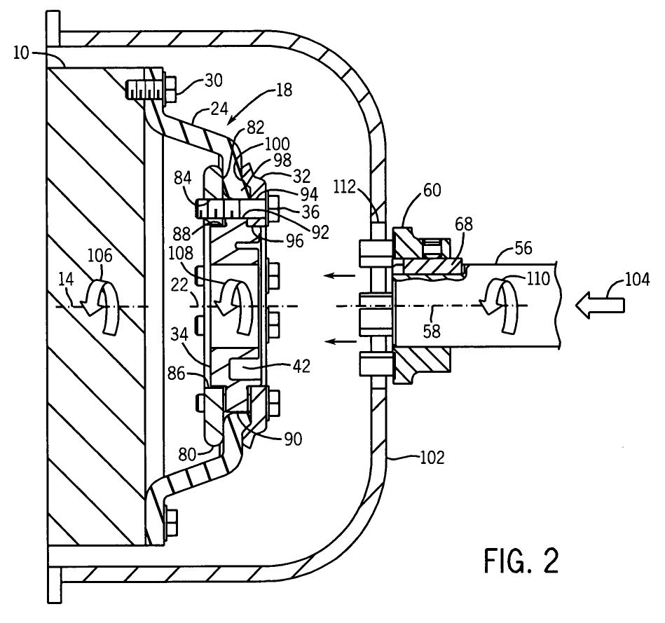

A flexible hub assembly 18 has a mating surface 20 that contacts the front face 12 of the flywheel 10. The flexible hub assembly rotates about an axis or centerline 22. The flexible hub assembly 18 has a number of elements, each of which will be discussed in more detail below, particularly in relation to FIG. 2. In general, the assembly includes a flexible element 24 that defines an outer flange 26 with a plurality of holes 28 extending therethrough. The holes 28 are located at a distance from the hub centerline 22 such that they align with the threaded holes 16 in the flywheel 10. Fasteners 30 are used to secure the flexible hub assembly 18 to the flywheel 10. The flexible hub assembly 18 can be delivered as one piece and quickly installed on the flywheel by simply engaging the fasteners 30 into the threaded holes 16 of the flywheel 10. The disk-like shape of the flexible element 24 reduces the overall profile of the assembly, allowing it to be installed and implemented in space constrained environments. The flexible element 24 is made from a compliant elastomeric flexing material such as a reinforced natural rubber or neoprene. Those skilled in the art will readily appreciate that the invention is not functionally limited to these specific material choices and any suitable compliant material could be used for the flexible element 24.

An external flange 32 secures the flexible element 24 to a hub 34. Clamping fasteners 36 load against the front face 38 of the external flange 32. The external flange 32 and the other elements used to secure the flexible element 24 to the hub 34 will be described in more detail in the discussion of FIG. 2 below.

The hub 34 has a front face 40 with a plurality of recesses 42 extending into the hub, generally in a circular pattern. The configuration of the recesses 42 provides for a plurality of inner keys 44 and outer keys 46. A plurality of inserts 48 having slots 50 are placed in the recesses 42 and engage the inner keys 44 and outer keys 46. This interface radially locates the inserts 48 in place allowing for the coupling to be blindly stabbed together during assembly, as described below. In a present embodiment, the inserts 48 are self constrained, that is, they fit snuggly into the recesses 42 of the hub 34, facilitating assembly of the coupling system when placed in service. Those skilled in the art will appreciate that the number and geometry of the hub 34 and inserts 48 could be varied from those shown and provide the same functionality. For example, the plurality of inserts 48 could be replaced with a one piece insert ring resulting in the same self constrained locating feature. The present embodiment only illustrates one geometry configuration for the self constrained insert 48 but is not functionally limited to this geometry. Furthermore, the inserts 48 used in the present embodiment are made of rubber or some other compliant material. This material choice results in a conformable cavity 52 eliminating the need for close internal clearance in the coupling. The net effect is that the coupling can transfer more torque and permit somewhat greater misalignment without sacrificing durability. Moreover, the hub 34 is shown with an inside diameter 54 which has the benefit of reducing the weight of the assembly.

The driven shaft 56 rotates about an axis or centerline 58 and is configured to engage a coupling element 60. The coupling element 60 has an inside diameter 62 with an internal key feature 64 that aligns with a key feature 66 in the driven shaft 56. A key 68 is used to transmit torque from the coupling element 60 to the driven shaft 56. The coupling element 60 has an outside diameter 70 with threaded holes 72 extending therethrough into the inside diameter 62. One or more set screws 74 are used to axially secure the coupling element 60 onto the driven shaft 56. Extensions 76 protrude axially from the front face 78 of the coupling element 60. The extensions 76 are configured to engage the cavities 52 formed by the recesses 42 and inserts 48, creating an intermeshing interface. Here again, those skilled in the art will readily appreciate that the number and geometry of the components of this intermeshing interface can be changed and still provide the same functionality. For example, the extensions 76 could be configured to protrude radially from the outside diameter 70 of the coupling element 60 rather than axially as shown. Also the intermeshing interface of the current embodiment could be reversed by having the extensions 76 on the hub 34 and the cavities 52 on the coupling element 60. The present embodiment only illustrates one geometry configuration for this intermeshing interface, but the invention is not functionally limited to this geometry.

FIG. 2. is a sectional view further illustrating the internal elements of the flexible hub assembly 18 and the manner in which the flexible element 24 is coupled to the hub 34. A protective cover 102 is shown that was not illustrated in FIG. 1. As shown, an internal flange 80 is positioned opposite the external flange 32. The internal flange 80 has a front face 82 having a plurality of threaded holes 84 extending therethrough. The clamping fasteners 36 pass through the hub 34 and engage the threaded holes 84 in the internal flange 80. The internal flange 80 has an inside diameter 86 that engages the outside diameter 88 on the hub, radially locating the flange. The hub has a stepped diameter 90 with a plurality of through holes 92. The external flange 32 has mating through holes 94 allowing the clamping fasteners 36 to pass therethrough. This configuration has the mechanical benefit of keying the hub 34 to the external flange 32 and internal flange 80 via the clamping fasteners 36. Those skilled in the art will appreciate that passing the clamping fasteners 36 through the stepped diameter 90 is not required but is implemented to increase the torque carrying capacity of the coupling system.

The flexible element 24 is coupled to the hub 34 via the clamping force created by the clamping fasteners 36. In particular, the inner periphery 98 of the flexible element 24 is captured by the clamping force created between the front face 82 of the internal flange 80 and the back face 100 of the external flange 32. The external flange 32 has an inside diameter 96 that engages the outside diameter 88 on the hub 34, radially locating the flange.

The blind stab flexible coupling system is ideal in situations where a protective cover 102 or other structure does not allow or limits access to the flexible hub assembly 18. In a typical engine flywheel application, the system is “blindly” stabbed together by installing the flexible hub assembly 18 and protective cover 102 onto and around the flywheel 10. The coupling is then engaged by axially moving the pre-installed coupling element 60 towards the installed flexible hub assembly 18 and blindly stabbing the coupling together, as indicated generally by reference numeral 104. The coupling element 60 approaches the flexible hub assembly via an opening 112 in the protective cover. Those skilled in the art will appreciate the simplicity and ease of engaging the current invention and its advantages over a system that requires the user to access the coupling after the two devices are placed adjacent one another within a cover, support assembly or other surrounding structure. It is especially advantageous where direct access to the coupling is limited due to a protective cover 102.

Once engaged, the coupling system transfers the flywheel torque 106 to the flexible hub assembly 18 via the flexible element 24, resulting in a hub assembly torque 108. The hub assembly torque 108 is then transferred to the driven shaft 56 via the coupling element 60, resulting in a drive shaft torque 110. The driven shaft torque 110 is then transferred from the coupling element 60 to the driven shaft 56 via the key 68 thus completing the coupling function. The compliant nature of the flexible element 24 allows for the misalignment of the flywheel centerline 14 to the driven shaft centerline 58. The flexible element 24 also dampens and isolates vibrations to or from the flywheel 10 to the driven shaft 56. Also, as discussed above, the inserts 48 reduce coupling internal clearance allowing for optimum conversion of flywheel torque 106 to drive shaft torque 110.

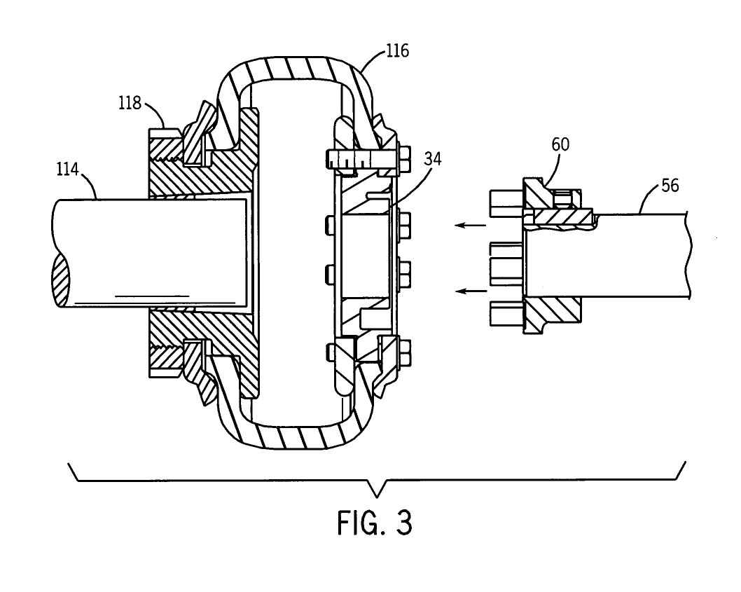

FIG. 3 is a sectional view of a first alternative embodiment of the current invention. A first rotating member 114 is shown as a shaft rather than the flywheel 10 illustrated in FIG. 2. The flexible element 116 is tire-like and is coupled to the hub 34 in the same manner described above. Tire-like flexible elements 116 of the type shown are commercially available under the designation “Para-Flex”, from Rockwell Dodge, a Rockwell Automation Company, located in Greenville, S.C. In this embodiment, a coupling element 60 is attached to the driven shaft 56 or second rotating member, and engages the hub 34 in the same manner as discussed above. A coupling mechanism 118 captures the flexible element 116 and is secured to the first rotating member 114. The configuration of the various components, and the manner in which the system may be stabbed following assembly on the shafts is generally similar to the arrangement described above.

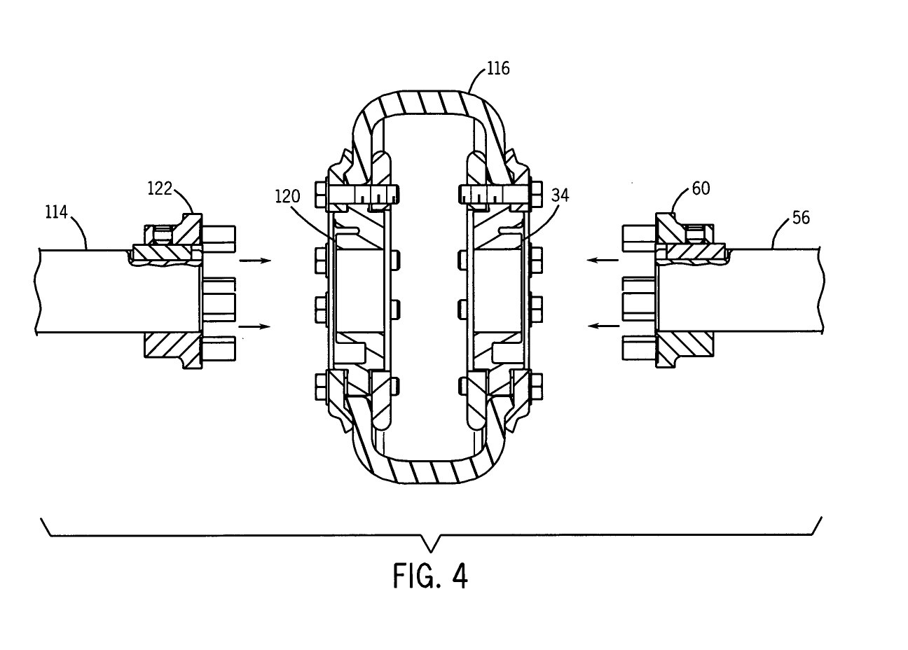

FIG. 4 is a sectional view of a second alternative embodiment of the current invention. The flexible element 116 is shown in the tire-like configuration as illustrated in FIG. 3. The coupling mechanism 118 shown in FIG. 3 is replaced by a combination of a second hub 120 and second coupling element 122. The second coupling element 122 is secured to the first rotating member 114 and engages the second hub 120 in same manner as the first coupling element 60 engages the first hub 34, thereby transferring torque to the driven shaft 56. Those skilled in the art will appreciate that this embodiment does not functionally differ from either of the previously presented embodiments insomuch as the components can be easily pre-assembled on their respective drive and driven elements, then stabbed together for final assembly.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A mechanical coupling system for coupling an engine flywheel to a driven shaft, comprising:
a flexible hub assembly including a hub fixedly coupled to a flexible element, the hub including a plurality of recesses in an axial face thereof, the flexible element extending radially from the hub and being configured to transmit torque from the flywheel; and
a coupling element configured to be secured to the shaft and having a plurality of extensions protruding generally parallel to an axis thereof, the extensions being engageable in the recesses for transmitting torque from the hub assembly to the shaft via the coupling element.

2. The mechanical coupling system of claim 1, wherein the hub assembly is configured to be preassembled on the flywheel prior to mating with the coupling element.

3. The mechanical coupling system of claim 1, further comprising at least one insert disposed within the recesses of the hub to form an interface between the extensions of the coupling element and the hub during operation.

4. The mechanical coupling system of claim 3, wherein the insert has an external slot configured to engage an internal key in the hub for radially locating the insert.

5. The mechanical coupling system of claim 3, wherein the insert is an elastomeric flexing material configured to conform to the recesses in the hub and extensions on the coupling element.

6. The mechanical coupling system of claim 1, wherein the extensions protrude from an axial face of the coupling element.

7. The mechanical coupling system of claim 1, wherein the hub assembly includes flanges that capture and compress an inner periphery of the flexible element.

8. The mechanical coupling system of claim 1, wherein the flexible element is disk-like.

9. A mechanical coupling system for coupling two rotating members to one another, comprising:
a hub assembly disposed adjacent to a first rotating member and having a plurality of recesses in an axial face thereof;
a flexible element configured to be secured to the hub assembly and to the first rotating member and to be captured by the hub assembly; and
a coupling element configured to be secured to a second rotating member and having a plurality of extensions protruding generally parallel to an axis thereof, the extensions being engageable in the recesses for transmitting torque between the first rotating member and the second rotating member via the hub assembly and flexible element.

10. The mechanical coupling system of claim 9, wherein the flexible element is disk-like.

11. The mechanical coupling system of claim 10, further comprising a plurality of fasteners for coupling the flexible element to the first rotating member.

12. The mechanical coupling system of claim 9, wherein the flexible element is tire-like.

13. The mechanical coupling system of claim 12, further comprising a second hub assembly disposed adjacent to the first rotating member, the second hub assembly capturing a portion of the flexible element.

14. The mechanical coupling system of claim 13, wherein the second hub assembly includes a plurality of recesses for mating with extensions from a second coupling element secured to the first rotating member.

15. The mechanical coupling system of claim 12, further comprising a coupling mechanism secured to the first rotating member and configured to capture a portion of the flexible element.

16. A mechanical coupling apparatus, comprising:
a hub comprising an intermeshing interface configured to mate with a complementary intermeshing interface of a coupling element mounted to a first rotating component;
a flexible element coupled to the hub and configured to engage a second rotating component; and
an internal flange and an external flange configured to compress the flexible element for securement to the hub.

17. The apparatus of claim 16, wherein the internal flange has an inside diameter, a clamping face, and a plurality of holes extending therethrough.

18. The apparatus of claim 17, wherein the external flange has an inside diameter, a clamping face, and a plurality of holes extending therethrough.

19. The apparatus of claim 18, wherein the hub has an outside diameter, a first portion of the outside diameter guiding the inside diameter of the internal flange and a second portion of the outside diameter guiding the inside diameter of the external flange thereby constraining the parts radially.

20. The apparatus of claim 16, wherein the intermeshing interface of the hub includes a plurality of recesses configured to receive extensions of the coupling element.
